(19) United States
(12) Patent Application Publication
(10) Pub. No.: US 2006/0085390 A1
(43) Pub. Date: Apr. 20, 2006

(54) METHOD AND SYSTEM FOR ONLINE REAL-TIME QUERY ABOUT CURRENT STATUS OF OPTICAL COMPONENT

(76) Inventors: Ming-Feng Ho, Hsin-Chu City (TW); HUA-JEN CHEN, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 10/711,952

(22) Filed: Oct. 15, 2004

(51) Int. Cl. G06F 17/30

(52) U.S. Cl. 707/3

(57) ABSTRACT

The present invention provides a method and a system for online real-time query about a current status of an optical component. The method includes setting up a database and utilizing the database for recording information about the current status of the optical component, wherein the information includes a manufacturing status of the optical component. The method also includes establishing a connection between the database and a remote terminal through the Internet and utilizing the remote terminal to read the information stored in the database for acquiring the current status of the optical component.

### BACKGROUND OF INVENTION

1. Field of the Invention

The present invention relates to a method and a system for querying about a current status of a product, and more specifically, to a method and a system for online real-time query about a current status of an optical component.

2. Description of the Prior Art

Nowadays, a product is produced in a way of division of labour, which means processes of design, manufacturing, processing and packing are not completed by a single company. The company instructs a manufacturer to produce a specific component of the product. When developing the product, the company does research on functions, a price, appearance, a market position, etc., of the product and then determines the detailed specification of the product. Afterwards, the company instructs other manufacturers to produce specific components of the product, respectively. In general, the company must monitor a progress of each component due to controlling time to market on the product, so that the product enters the market on the predetermined date. Also, it is necessary for manufacturers that produce components of the product to provide information related to the components, such as progress information, in order to satisfy requirements demanded by a customer.

Currently, during manufacturing processes, most manufacturers monitor and manage processes on a production line using a manufacturing execution system (MES). The manufacturing execution system, well-known to those of ordinary skill in the art, is capable of controlling and recording actual production situations and conditions, such as a processing progress, yield rate, scrap rate, rework rate, etc., of each order. Therefore, for the manufacturer, adopting a conventional manufacturing execution system helps improve production efficiency.

Therefore, when the customer queries a manufacturer about production progress of the product, the manufacturer usually reports information retrieved with the manufacturing execution system back to the customer. In general, the customer contacts the manufacturer via telephone or e-mail first, and then customer service representatives of the manufacturer manually query data existing in the manufacturing execution system and further report production progress of the product back to the customer. The significant disadvantage of the above-mentioned query process is the need to report information back to the customer manually. Therefore, the manufacturer must assign employees to receive query requests from the customer, and manually queries data required by the customer. Due to staff limitations, the manufacturer may not satisfy query requests for several customers simultaneously, and the processing of some query requests will be delayed. In addition, it is not efficient to make a query manually. Hence, not only will the customer not be satisfied with the service quality provided by the manufacturer, but also the customer cannot control or manage the production progress efficiently.

### SUMMARY OF INVENTION

It is therefore a primary objective of the claimed invention to provide a method and a system for online real-time query about a current status of an optical component to solve the above-mentioned problem.

According to the claimed invention, a method for online real-time query about a current status of an optical component is disclosed. The method includes: setting up a database and utilizing the database for recording information about the current status of the optical component, wherein the information includes a manufacturing status of the optical component; establishing a connection between the database and a remote terminal through the Internet; and utilizing the remote terminal to read the information stored in the database for acquiring the current status of the optical component.

In addition, the claimed invention provides an online real-time query system for online real-time query about a current status of an optical component. The online real-time query system includes: a server utilized for hosting a database to record information about the current status of the optical component, wherein the information contains a manufacturing status of the optical component; and a remote terminal coupled to the server through the Internet for reading the information stored in the database for acquiring the current status of the optical component.

The method and the system according to the claimed invention for online real-time query about a current status of an optical component store the latest production information produced by a manufacturing execution system into a server in real-time. Hence, the customer can query the latest status of the product through an Internet connection whenever he wants without any manual assistance provided by the manufacturer. Thus, not only does the manufacturer reduce the needed staff size and avoid mistakes occurring while manually querying the information, but also the customer can obtain desired information related to the optical component more quickly.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a first embodiment of an online real-time query system according to the present invention.

FIG. 2 is a block diagram of a second embodiment of an online real-time query system according to the present invention.

FIG. 3 is a block diagram of a third embodiment of an online real-time query system according to the present invention.

### DETAILED DESCRIPTION

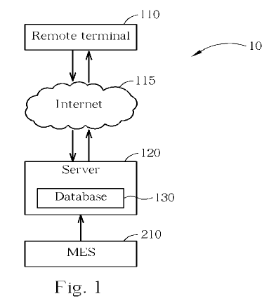

Please refer to FIG. 1. FIG. 1 is a block diagram of a first embodiment of an online real-time query system 10 according to the present invention. The online real-time query system 10 comprises a remote terminal 110, the Internet 115, and a server 120. The remote terminal 110 is connected to the Internet 115 via wired or wireless means. Hence, a network connection between the remote terminal 110 utilized by a customer and a server 120 set up by a manufacturer is established through the Internet 115. Next, the server 120 activates its own security authorization mechanism (i.e., a login system) installed in the server 120. For example, the server 120 requires the customer to input a user name and a corresponding password through a web page displayed on the remote terminal 110. Then the server 120 verifies if the authorization data inputted by the customer conforms to security rules formulated according to the security authorization mechanism. If the authorization data conforms to the security rules, the customer can log in to the server 120 for reading information stored in the database 130. In the present embodiment, the information stored in the database 130 is retrieved from a manufacturing execution system (MES) 210. The MES 210 monitors and records actual situations and conditions of a product on production lines, such as information about situations, problems, etc., when the product is produced by equipment during production, and transmits the above-mentioned information to the server 120 in real-time. Please note that the above-mentioned term “real-time” means that if the MES 210 produces any new data, the new data will be immediately transmitted from the MES 210 to the server 120 to update the information recorded in the database 130 that is stored in the server 120. Therefore, after the customer successfully logs in to the server 120, he/she can obtain the latest information and condition status pertaining of the product. The detailed operation is described as follows.

After the customer successfully logs in to the server 120 through the remote terminal 110, the server 120 decides the following data query flow path according to a user name inputted by the customer when he/she logs in to the server 120 in order to optionally display the data/information provided by the MES 210. For example, suppose the above-mentioned manufacturer produces masks, and customers instruct the manufacturer to produce masks required by various chips. Hence, each order submitted by a customer has a corresponding transaction ID. After the customer successfully logs in to the server 120, the server 120 provides a list shown through a web page displayed on the remote terminal 110. The list contains each transaction ID respectively corresponding to each order. Therefore, the customer can select a transaction ID from the list to query a current status of a mask corresponding to the transaction ID. Next, the server 120 reads data from database 130 according to the transaction ID selected by the customer, and displays the data on a web page displayed on the remote terminal 110. Meanwhile, information obtained by the customer contains a batch number of a mask, a work station currently processing the mask, the predetermined delivery date of the mask, the history record of the mask, etc. In addition, if the customer needs more detailed information, the server 120 can provide corresponding information desired by different customers having different requirements. Thus, the online real-time query system 10 according to the present invention is a real-time processing system. The MES 210 transmits the latest production information to the server 120. Therefore, the customer can query the latest status of the product through an Internet connection whenever he wants without requiring any manual assistance to be provided by the manufacturer. Hence, not only does the manufacturer reduce the needed staff size and avoid mistakes occurring while manually querying the information, but also the customer can obtain desired information related to the optical component more quickly.

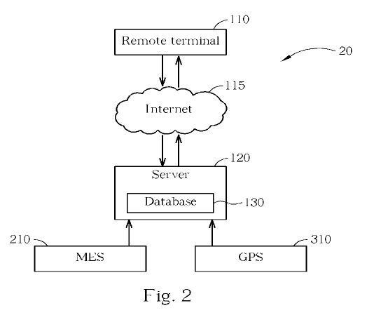

Please refer to FIG. 2. FIG. 2 is a block diagram of a second embodiment of an online real-time query system 20 according to the present invention. In FIG. 2, in addition to the remote terminal 110, the server 120, the database 130 and the MES 210, the online real-time query system 20 further contains a global positioning system (GPS) 310. Please note that functions and operations performed by the remote terminal 110, the server 120, database 130 and the MES 210 are disclosed in description of last embodiment and not described again in this paragraph. Meanwhile, for necessity, functions and operations performed by the GPS 310 are described as follows. After the manufacturer completes manufacturing or processing an optical component, such as the above-mentioned mask, the optical component is delivered to the customer by services provided by a transport service provider. According to the present invention, the GPS 310 being installed in each type of transport means the GPS 310 is used by the transport service provider for tracing a position and a status of the product during product delivery period, in order to ensure that the product arrives at a delivery destination. Therefore, in addition to transmitting data stored in the MES 210 to the database 130 of the server 120, information stored in the GPS 310 can also be transmitted to the database 130 of the server 120 by any conventional mechanisms, such as satellite communication. Thus, the customer not only can obtain information related to the production situation, predetermined delivery date, the history record of the optical component, etc. from the server 120, but can also obtain a current position of the optical component during a product delivery process. Thus, the customer can know the status of the optical component more clearly and predict when the optical component will arrive at the delivery destination more precisely in order to arrange an appropriate following process flow.

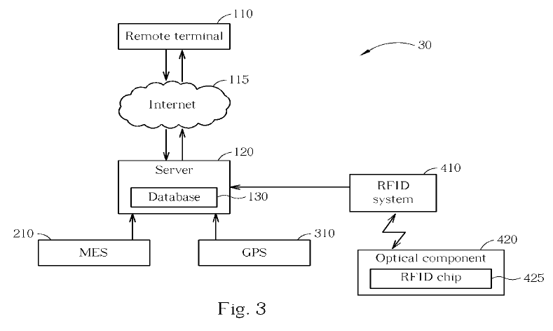

Please refer to FIG. 3. FIG. 3 is a block diagram of a third embodiment of an online real-time query system 30 according to the present invention. In FIG. 3, in addition to the remote terminal 110, the server 120, the database 130, the MES 210 and the GPS 310, the online real-time query system 30 further contains a radio frequency identification (RFID) system 410. Please note that functions and operations performed by the remote terminal 110, the server 120, database 130, the MES 210 and the GPS 310 are disclosed in the above-mentioned embodiment and not described again in this paragraph. Meanwhile, for necessity, functions and operations performed by the RFID system 410 are described as follows. The RFID system 410 reads information stored in a radio frequency identification (RFID) chip 425 using a radio frequency (RF) signal. Compared with other identification technologies, the above-mentioned technology has advantages of being water proof, diamagnetic, durable in high temperatures, having a long lifetime, etc. Hence, in the present embodiment, for satisfying requirements demanded by a customer, a RFID chip 425 is added in each optical component 420. Thus, after the above-mentioned transport service provider delivers the optical component 420 to the customer, the RFID system 410 installed on the client terminal can continuously trace a position and a status of the optical component 420, and transmits the information related to the optical component 420 to the database 130 of the server 120 by any conventional data transmission method. Hence, after the customer logs in to the server 120 and selects to query the optical component 420, he can query a position and a status of the optical component 420 which has been delivered to the customer. The customer can obtain all information and history records of the optical component 420 undergoing production, delivery, and usage by the customer because the database 130 of the server 120 records the information uploaded by the MES 210 and the GPS 310. Consequently, the customer can manage the optical component 420 more efficiently and improve the efficiency of business operation.

In contrast to the prior art, the method and the system for online real-time query about a current status of an optical component 420 (such as a mask) stores the latest production information produced by a manufacturing execution system into a server in real-time. Hence, the customer can query the latest status of the optical component 420 through an Internet connection whenever he wants without any manual assistance provided by the manufacturer. Thus, not only does the manufacturer reduce the needed staff size and avoid mistakes occurring while manually querying the information, but also the customer can obtain desired information related to the optical component 420 more quickly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for online real-time query about a current status of an optical component, comprising:
setting up a database and utilizing the database for recording information about the current status of the optical component, wherein the information includes a manufacturing status of the optical component;
establishing a connection between the database and a remote terminal through the Internet; and
utilizing the remote terminal to read the information stored in the database for acquiring the current status of the optical component.

2. The method of claim 1, wherein the optical component is a mask.

3. The method of claim 2, further comprising:
providing a manufacturing execution system (MES) and utilizing the manufacturing execution system for transmitting the information to the database.

4. The method of claim 2, further comprising:
providing a global positioning system (GPS) and utilizing the global positioning system for transmitting the current position of the mask to the database.

5. The method of claim 2, wherein the information further comprises positional information, and the method further comprises:
providing a radio frequency identification (RFID) system;
building a chip in the mask; and
utilizing the RFID system for detecting the chip to generate the positional information and transmitting the positional information to the database.

6. The method of claim 2, further comprising:
providing a login system and utilizing the login system for controlling reading the information corresponding to the mask stored in the database according to security rules;
wherein if login data inputted by the remote terminal into the login system conforms to the security rules, the login system allows the remote terminal to read the information.

7. An online real-time query system for online real-time query about a current status of an optical component, comprising:
a server utilized for hosting a database to record information of the current status of the optical component, wherein the information contains a manufacturing status of the optical component; and
a remote terminal coupled to the server through the Internet for reading the information stored in the database for acquiring the current status of the optical component.

8. The online real-time query system of claim 7, wherein the optical component is a mask.

9. The online real-time query system of claim 8, further comprising:
a manufacturing execution system (MES) coupled to the server for transmitting the information to the database.

10. The online real-time query system of claim 8, further comprising:
a global positioning system (GPS) coupled to the server for transmitting the current position of the mask to the database.

11. The online real-time query system of claim 8, wherein a chip is installed on the mask, and the information further comprises positional information, and the online real-time query system further comprises:
a radio frequency identification (RFID) system coupled to the server for detecting the chip to generate the positional information and transmitting the positional information to the database.

12. The online real-time query system of claim 8, wherein the server is further utilized for executing a login system to control reading the information corresponding to the mask stored in the database according to security rules, and if login data inputted by the remote terminal into the login system conforms to the security rules, the login system allows the remote terminal to read the information.
